(19) United States
(12) Patent Application Publication
(10) Pub. No.: US 2022/0366505 A1
(43) Pub. Date: Nov. 17, 2022

(54) INSURANCE BIDDING PLATFORM

(71) Applicant: Wells Fargo Bank, N.A., San Francisco, CA (US)

(72) Inventor: Mushnuri Veera Venkata Kiran Kumar, Hyderabad (IN)

(21) Appl. No.: 16/833,822

(22) Filed: Mar. 30, 2020

(51) Int. Cl. G06Q 40/08; G06Q 40/02; G06F 16/182; H04L 9/06

(52) U.S. Cl. CPC G06Q 40/08; G06Q 40/025; G06F 16/1834; H04L 9/0637

(57) ABSTRACT

An insurance bidding platform allows users to select insurance from numerous insurance providers. The platform supports automatic communication of customer data from a financial institution to a myriad of insurance providers. Based on the customer data, insurance providers generate and convey bids or offers for insurance to customers. After a customer accepts a bid for insurance, a smart contract can be constructed, and transmitted to a peer-to-peer network that saves the smart contract to a distributed database in a sequence of cryptographically secure blocks that are verified by copies in the peer-to-peer network.

### BACKGROUND

Insurance is a risk management tool to protect against an uncertain loss. An insurance transaction involves a promise by an insurance provider to compensate an insured in the event of a covered loss in exchange for payment from the insured. Most of the time, insurance is optional such as life insurance or long term health insurance. However, in some situations insurance is required, for example by rule, law or regulation. In one instance, if an individual seeks a mortgage for a new home, but does not have a requisite down payment, such as twenty percent, the individual may be required to purchase mortgage insurance to reduce the risk for a financial institution in the event of a default. Oftentimes, the financial institution can select an insurance provider for mortgage insurance in conjunction with processing a mortgage. Alternatively, the financial institution can identify a number of providers of mortgage insurance for consideration by the customer.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to an insurance bidding platform. Insurance providers can register with the platform, or system, to provide bids or offers for insurance. Customers of a financial institution can provide data associated with acquisition of a mortgage loan, for example. Subsequently, a customer can be directed to the insurance bidding platform to acquire mortgage insurance. The data or a subset of data associated with the loan from the financial institution can be communicated automatically to insurance providers by way of the platform. Premium bids based on the data can be received from insurance providers and presented to the customer. The customer can accept the bid of one insurance provider or submit a counter bid or offer for acceptance of an insurance provider. After an agreement is reached between the customer and an insurance provider, a smart contract can be constructed capturing terms and conditions. The smart contract can subsequently be transmitted to a peer-to-peer network that saves the smart contract to a shared, synchronized, distributed data store such as a distributed ledger. In one instance, the smart contract can be transformed to a block representation and saved to a sequence of cryptographically secure blocks that are verified by copies in the peer-to-peer network. In accordance, with one aspect, the smart contract or data related thereto can be made available to parties to the contract as well as designated third parties such as auditors or regulators.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation.

FIG. 2 is a schematic block diagram of a sample insurance bidding system.

FIG. 3 is illustrates insurance transaction persistence with a block chain network.

FIG. 4 is a flow chart diagram of a method of insurance provisioning.

FIG. 5 is a flow chart diagram of a method or acquiring insurance.

FIG. 6 is a flow chart diagram of a method of bid prediction.

FIG. 7 is a schematic block diagram illustrating a suitable operating environment for aspects of the subject disclosure.

### DETAILED DESCRIPTION

The lowest premium for an insurance policy may not be from one or more preselected insurance providers, especially when a beneficiary recommends the one or more insurance providers. Consider mortgage insurance, for example. A mortgagee can be required to obtain mortgage insurance that protects a financial institution against loss, for instance in case of default on payment. In situations in which the financial institution utilizes a preferred mortgage insurance provider, it is possible the premium for the insurance is higher than it otherwise would have been if another insurance provider was used. Further, fraud or at least an appearance of impropriety is possible. For example, a financial institution may receive payment from an insurance provider to use that insurance provider as the default or preferred provider. Presenting a number of insurance providers appears to avoid these issues, since choice is involved. However, the insurance providers may still not provide the best rate and may also pay the financial institution to be included as a possible choice. The conventional approach lacks trust and transparency with respect to insurance acquisition. For instance, market influence of the insured entity is unknown. Further, it is difficult to acquire information about the totality of an insurance transaction for evaluation.

Details provided herein generally pertain to an insurance bidding system or platform. The insurance bidding platform creates an open marketplace for purchase of insurance from substantially any insurance provider that wishes to participate. Data associated with an individual or entity, such as from a loan application, can be automatically communicated from a financial institution to insurance providers. In response, premium quotes, bids or offers can be produced based on the data and presented to the individual. The individual can evaluate the offers and select an offer to accept. Additionally or alternatively, the individual can propose a different premium that can be accepted by an insurance provider. After an insurance policy and associated premium are agreed upon by the parties, a smart contract is constructed and transmitted to a peer-to-peer network that saves the smart contract to a distributed database in a sequence of one or more blocks that are cryptographically secure and verified in the peer-to-peer network. In other words, a secure and immutable record of an insurance transaction is established. This enhances trust associated with insurance acquisition. Further, access can be provided to one or more third parties, such as auditors or regulators, thereby providing transparency for such transactions as well as further increasing trust.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

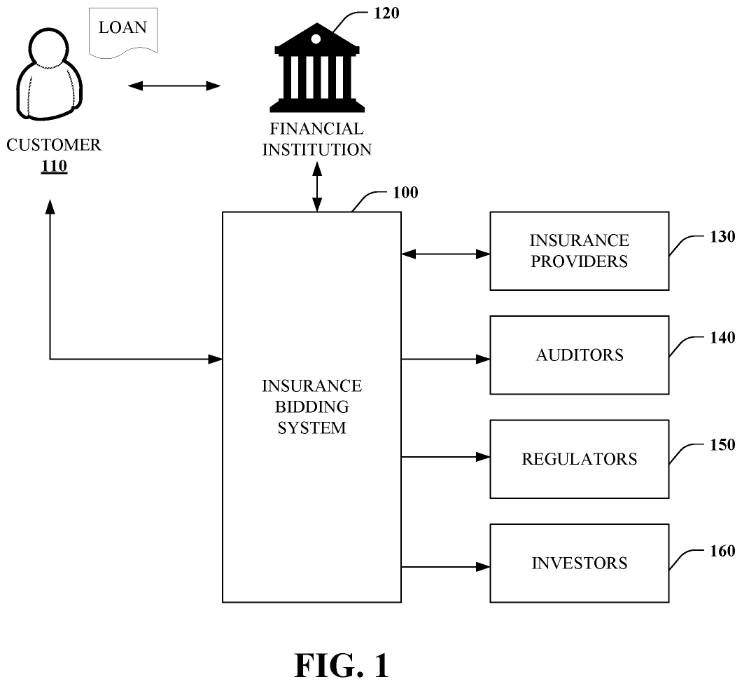

Referring initially to FIG. 1, a high-level overview of an example implementation is illustrated and described hereinafter. As depicted, the implementation includes insurance bidding system 100. The insurance bidding system 100 provides a means for matching individuals with insurance providers as well as providing a transparent process by way of a digital ecosystem. In accordance with one embodiment, various functionality of the insurance bidding system 100 can employ block chain technology, which generally provides a decentralized, distributed, and digital ledger that saves transactions across a network of computers such that a record in the ledger cannot be altered retroactively.

In FIG. 1, a customer 110 of a financial institution 120 can apply for a mortgage loan from the financial institution. To apply, the customer 110 can provide various information about the customer, or, in other words, customer data, such as name address, social security number, job, and salary, among other things, as well as identification of a parcel subject to the mortgage. The financial institution 120 can utilize this information and obtain a credit score from one or more credit agencies. In one instance, a down payment by the customer 110 is less than a threshold. As such, the customer 110 may be required to acquire mortgage insurance to be approved for a mortgage loan, wherein the mortgage insurance protects the financial institution 120 against loss from default. In furtherance thereof, the financial institution 120 can direct the customer to the insurance bidding system 100. Further, the financial institution 120 can automatically transfer data regarding the customer 110 and mortgage parcel to the insurance bidding system 100 to improve efficiency by avoiding reentry of data already provided to the financial institution 120.

The insurance bidding system 100 can transmit customer data such as credit score as well as a corresponding mortgage parcel to one or more insurance providers 130. The insurance providers 130 register with the insurance bidding system 100 to compete for customers in the mortgage insurance domain. The insurance providers 130 can utilize the customer data to generate a premium bid or offer for mortgage insurance. The insurance bidding system 100 can receive the bid from one of the insurance providers 130 and communicate the bid to the customer 110, for instance by way of a customer interface or dashboard provided by the insurance bidding system 100. In one instance, other insurance providers 130 can be notified of the bid provided to the customer 110 and provided with an opportunity to submit additional bids to the customer 110. In this manner, the insurance providers 130 can compete for the business of the customer 110. The bids can be a function of credit score of the customer, such that the bids can be lower for good customers, namely customers with good credit scores. The customer 110 can subsequently review the bids and select or accept a bid. Additionally or alternatively, the customer 110 can make a counter offer or bid provided to one or more of the insurance providers 130. For example, the customer 110 can receive a bid for one thousand dollars a year and provide a counter offer of eight hundred dollars a year, which may be reasonable and acceptable to an insurance provider given the quality of customer as determined based on credit score. The insurance bidding system 100 can also analyze historical data and provide predictions or suggestion regarding premiums given similarity of the customer 110 to previous customers. After the customer 110 accepts a bid, or an insurance provider 130, accepts a counter bid, the transaction can be finalized and recorded. In one instance, a smart contract can be generated and saved to a block chain distributed database.

The insurance bidding system 100 can provide access, such as read-only access, to various third parties. In one instance, auditors 140 can access the insurance bidding system 100. The auditors can seek to audit the transactions captured by the system, for example to ensure parties, premiums, and other terms are captured correctly. In another instance, regulators 150 can be provided access to the insurance bidding system 100. The regulators 150 can be individuals or entities seeking to access compliance with federal, state, local, or industry regulations, restrictions or guidelines. Investors 160 can also be provided access. The financial institution 120 can at some time during the term of the loan sell the loan to an investor. The insurance bidding system enables potential investors and investors to view transactions related to mortgage insurance. In one instance, the insurance bidding system 100 can generate reports, for example in near real time, including information pertinent to investors. Additionally, the financial institution 120 or separate loan servicing entity can interact with the insurance bidding system 100 to acquire needed data. For example, the premium amount of the accepted mortgage insurance can be acquired, divided into monthly payments, collected and escrowed to pay the premium when due.

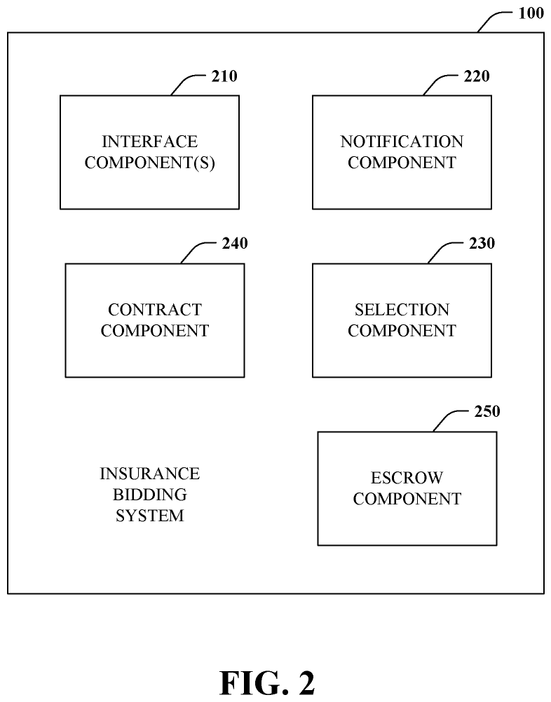

FIG. 2 is a schematic block diagram illustrating the insurance bidding system 100 in further sample detail. The insurance bidding system 100 includes interface component(s) 210, notification component 220, selection component 230, contract component 240, and escrow component 250. The interface component(s) 210 provide a mechanism to interact with the insurance bidding system 100. The notification component 220 generates notifications regarding bids for a customer or insurance provider, and the selection component 230 enables detection of a selection of a bid or acceptance of an offer. The contract component 240 generates a smart contract for a customer and insurance provider, and the escrow component 250 computes an escrow amount to be collected monthly for a mortgage. In one embodiment, the interface component(s) 210, notification component 220, selection component 230, contract component 240, and escrow component 250 are computer executable components that when executed by a computer cause the computer to implement functionality of the insurance bidding system 100 as described herein.

The interface component(s) 210 comprises one or more user interfaces to enable interaction with the insurance bidding system 100. In one instance, the interface component 210 can be a graphical user interface provided to allow a user to receive and view offers from insurance providers and optionally generate counter offers. In another instance, the interface component 210 can correspond to an interface that enables on-boarding of and use by insurance providers to receive customer data and generate bids for insurance. In still another instance, third parties such as auditors, regulators, or investors, can be provided with an interface component 210 that allows read-only access to particular data. Of course, the interfaces may be different. For example, an interface associated with an investor could be configured to generate reports or the like regarding information likely to be of interest to the investor. In yet another instance, an interface component 210 can be employed to allow interaction by loan originators or services to facilitate generation of bills, reports, or the like, including near real time generation thereof.

The notification component 220 is a mechanism for notifying individuals or entities about events in the insurance bidding system 100. In one scenario, the notification component 220 can notify a customer about one or more bids received. An insurance provider can also be notified by way of notification component 220 of the existence of an offer or counter offer from a customer. Additionally, in one instance, the notification component 220 can notify an insurance provider regarding bids of other insurance providers. For example, an insurance provider can be notified of the existence of a lower bid by a different insurance provider, thereby providing an opportunity to meet or beat the bid. In one instance, bids can be ranked based on premium and provided by way of the notification component 220 to the insurance providers. Communications of data regarding bids of other insurance providers can result in the insurance providers competing against one another for business of a customer. As such, a customer can receive a competitive bid with little or no effort.

The selection component 230 enables detection of a selection of a bid or offer and triggers further processing. More specifically, the selection component 230 can monitor interactions between customers and insurance providers including bid presentation and counter bids to identify final selection of a bid. For example, if an insurance provider provides a bid to a customer and the customer accepts the bid by selecting the bid, the selection component 230 can identify this selection as acceptance of the bid and trigger subsequent processing including generation of a contract by the contract component 240.

The contract component 240 generates an agreement or contract documenting a bid, or offer, acceptance thereof, and further details including price and other terms or conditions. In one embodiment, the contract component 240 can generate a smart contract capturing the transaction. A smart contract is similar to a contract in the physical world except it is digital and captured in computer code. Further, the smart contract can be self-executing in accordance with the terms of the contract, for example, controlling transfer of assets (e.g., digital currency) between parties under certain conditions. Here, the smart contract can encode terms associated with an insurance policy into a computer program. In one instance, the smart contract can be decentralized and recorded on a distributed database platform that can secure and validate the transaction. Further, the smart contract can be saved in a manner that cannot be changed without all parties knowing. In one instance, the smart contract can be stored in accordance with block chain technology.

The escrow component 250 provides a means for determining an escrow amount and enabling payment out of an escrow account. The escrow component 250 can determine a yearly premium from the contract. Subsequently, the escrow component 250 can compute a monthly payment to cover the premium and add that escrow amount to the loan payment. As dictated by the contract, the amount due can be debited from a designated account. In accordance with one embodiment, the escrow component 250 can collect information for determining the escrow amount and provide that information to a originating financial institution or mortgage servicing entity to compute monthly payment, add the payment to a mortgage payment amount, and pay the premium when due. In an alternate embodiment, the escrow component 250 can provide information to a customer to enable direct payment by a customer.

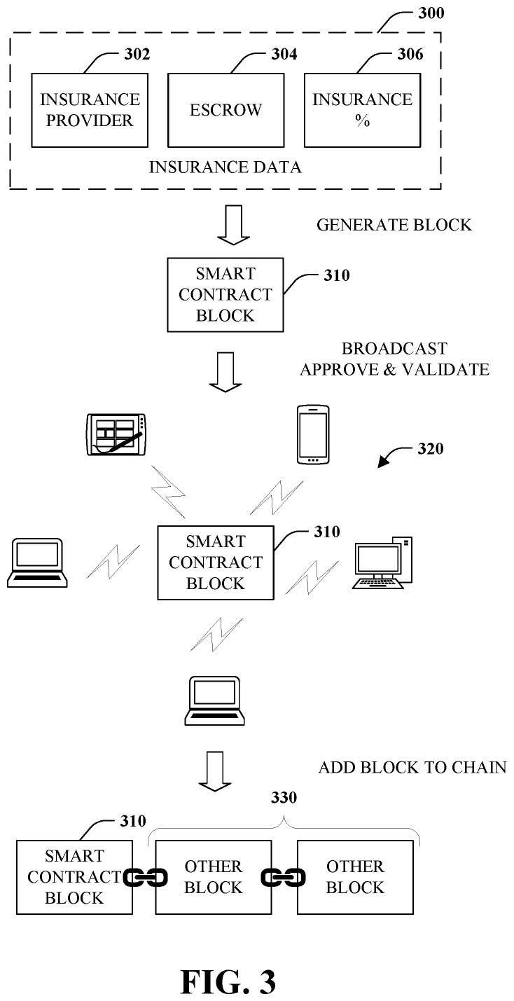

Turning attention to FIG. 3, a smart contract block 310 can be generated in accordance with one embodiment. The smart contract block 310 captures contract terms associated with a transaction between a customer and an insurance provider in programmatic code that can be self-executing. For example, the smart contract block can include the identity of a selected insurance provider 302, escrow amount 304, and insurance percentage 306. Additional data captured by the smart contract block 310 can include terms and conditions as well as triggering events, among other things. Here, the smart contract block 310 is a particular digital representation of an agreement between parties to an insurance transaction.

The smart contract block 310 can be broadcast to a plurality of computing devices in a decentralized, distributed, peer-to-peer network 320. The network 320 can be public, private, permissioned, or consortium, among others. In a public network anyone can join and participate with little or no privacy for transactions. Alternatively, a private network can be similar to a public network with the exception that one organization governs the network and controls who is allowed to participate. A permissioned network requires participants to acquire permission to join either a public or private network. In a consortium, multiple organizations can share governing responsibilities including who may submit transactions and or access data.

Each participant computing device in the network 320 receives the broadcasted smart contract block 310 and validates, or checks, the smart contract block against some validation rules set up by creators of the network 320. If the smart contract block 310 satisfies all validation rules it is deemed valid or approved. Otherwise, the smart contract block 310 is deemed invalid or unapproved. After being deemed valid or approved the smart contract block 310 can be added to a chain of other blocks 330. Moreover, the smart contract block 310 can be linked with cryptography. For example, the smart contract block 310 can comprise a cryptographic hash of a previous block, timestamp, and transaction data. The collection of blocks is a block chain or linked list of records that can represent a decentralized digital ledger, a copy of which is distributed on computers of the network 320.

In accordance with one embodiment, a financial institution, such as a bank, can set up a private block chain network as backend support for an insurance bidding system or service. The financial institution can invite insurance providers to participate. In conjunction with a mortgage approval process, the financial institution can invite customers of the financial institution to participate in the insurance bidding service. A smart contract can be generated and saved in the private block chain network. The financial institution can also provide read access to the private block chain to any number of third parties including but not limited to auditors, regulators, and investors.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Further, communication between systems, components and/or sub-components can be accomplished in accordance with either a push and/or pull control model. The components may also interact with one or more other components not specifically described herein for sake of brevity, but known by those of skill in the art.

Various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, among others, can automate certain mechanisms or processes performed thereby to make portions of the systems and methods more adaptive as well as efficient and intelligent. By way of example, and not limitation, the insurance bidding system 100 and various components thereof can utilize such mechanisms to identify bids given a customer profile and historical data or classify provided bids based on similar data. Such technology can assist in identification of an appropriate bid or evaluating a provided bid, among other things.

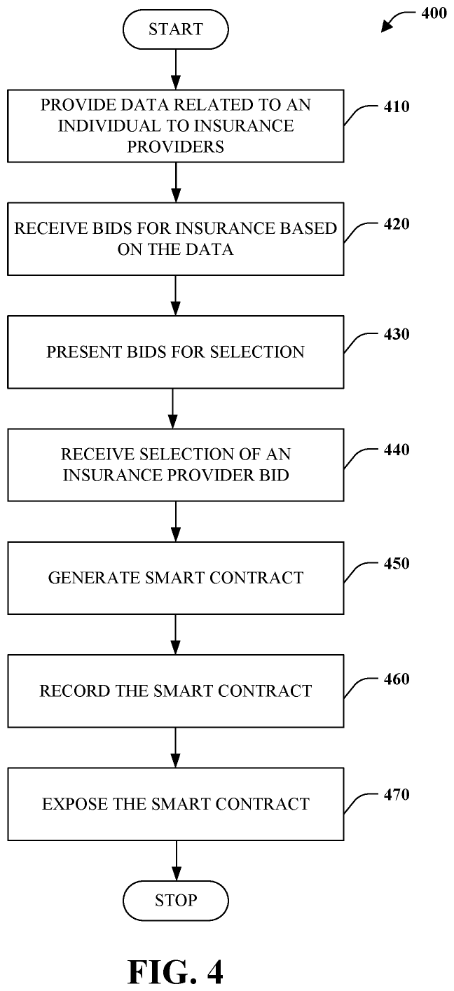

In view of the exemplary systems described above, methods that may be implemented in accordance with the disclosed subject matter will be better appreciated with reference to flow chart diagrams of FIGS. 4-6. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 4 illustrates a method 400 of insurance provisioning. The functionality associated with method 400 can be performed by the insurance bidding system 100. At reference numeral 410, data related to individuals or entities can be provided to insurance providers. For example, a credit score of an individual can be provided to insurance providers associated with providing mortgage insurance or other insurance products or services. In accordance with one embodiment, a financial institution can provide data acquired from its customer in conjunction with a loan application, such as name, gender, geographic location, and identification of a mortgage parcel, which can subsequently be made available to insurance providers. Consequently, data entry and acquisition time is reduced.

At 420, one or more bids for insurance can be received from insurance providers. The bids, or offers, can be generated, including a premium percentage against a mortgage parcel, based on data regarding an individual or entity such as credit score or geographic location, among other things. Insurance providers will compete for good customers. For example, for an individual with a good credit score, a bid for mortgage insurance can be an annual premium of one thousand dollars. By contrast, a bid for the same mortgage insurance for an individual with a poor credit score can be one thousand six hundred dollars.

At 430, the bids are presented to a system user for selection. In accordance with one aspect, a graphic user interface associated with the insurance bidding system can be exposed and employed to select a bid. For example, an application alert can be triggered after arrival of a bid from an insurance provider. However, other notification mechanisms are also supported including but not limited to text message. Further, more than one bid can be presented, for example from multiple distinct insurance providers. In some cases, bids from an insurance provider can change or be updated as insurance providers compete on the basis of premium or other terms. In some instances, insurance providers can provide multi-policy discounts. Accordingly, a premium bid can be conditioned on purchasing another insurance policy from an insurance provider. In one embodiment a tool can be provided to insurance providers or potential customers to generate or evaluate a bid based on historical information regarding similar customers. At 440, selection of an insurance bid can be received from an individual or entity. Here, selection is indicative of acceptance of the bid or offer.

At 450, a smart contract is generated capturing a transaction between an individual or entity and an insurance provider. The smart contract can captured transactional details in programming code. For example, the premium, due date, parcel, and other terms or conditions can be encoded in a smart contract.

At 460, the smart contract can be recorded or saved to a computer-readable storage medium. In accordance with one embodiment, a distributed ledger can be utilized to record the smart contract, wherein the distributed leger is a type of data store that is shared, replicated, and synchronized among members of a decentralized network. Further, block chain technology can be employed to improve tamper resistance. In this case, the smart contract can be converted into a block representation that includes, among other things, a cryptographic hash of a prior block such that blocks are linked or chained together from the first block to the most current block. The chain of blocks, or block chain, can correspond to the distributed ledger that is replicated across the network.

At numeral 470, the smart contract or aspects thereof are exposed to one or more parties. In other words, access is provided to the smart contract or aspects thereof. In one instance, parties to the smart contract are provided access, such as the insured and insurance provider. Moreover, access can be provided to one or more third parties to the smart contract. In one instance, the smart contract can be made available to a financial institution or loan servicing entity. For example, a loan servicing entity can receive information about the premium of mortgage insurance policy to enable an escrow account to be established and employed to collect payment from the insured monthly and pay the premium when due. Auditors can also be provided access to ensure accuracy of transactions and detect fraud, among other things. Further, regulators can access information to ensure compliance with various rules or regulations including federal mortgage insurance regulations associated with conventional and government-backed mortgages.

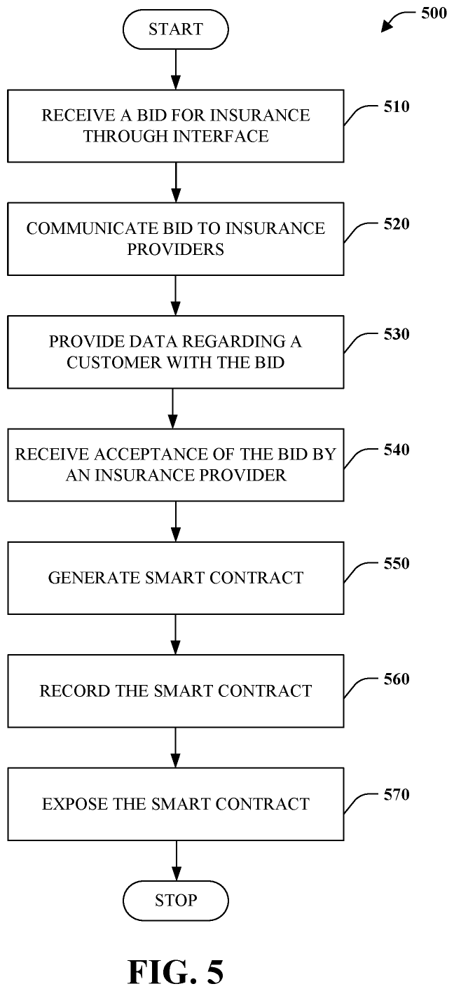

FIG. 5 depicts a method 500 of acquiring insurance. The method 500 can be implemented by the insurance bidding system 100 or various components thereof including the interface component 210 and notification component 220, among others. At reference numeral 510, a bid is received for insurance from a potential customer. For example, a bid can be submitted for mortgage insurance for a particular amount. At numeral 520, the bid is communicated to one or more insurance providers. Additionally, data regarding the potential customer can be provided or otherwise made available to the one or more insurance providers. For instance, credit score of a potential customer and, in the case of mortgage insurance, the amount of a loan and down payment can be made available. At 540, an acceptance of the bid or offer can be received from an insurance provider. At reference 550, a smart contract can be generated capturing premium as well as various other terms and conditions. The smart contract, or cryptocontract, can correspond to an executable computer program that controls the transfer of digital currency or other assets between parties to the contract under certain conditions specified by the contract. At 560, the smart contract is recorded or saved to a data store. For instance, the smart contract can be stored on block chain technology comprising a decentralized ledger. At 570, the smart contract is exposed, or made accessible, to parties to the contract as well as various third parties as desired. For example, the smart contract can be made available to a financial institute or loan servicing entity to enable payment. Alternatively, the smart contract can be made available to auditors, regulators, or investors.

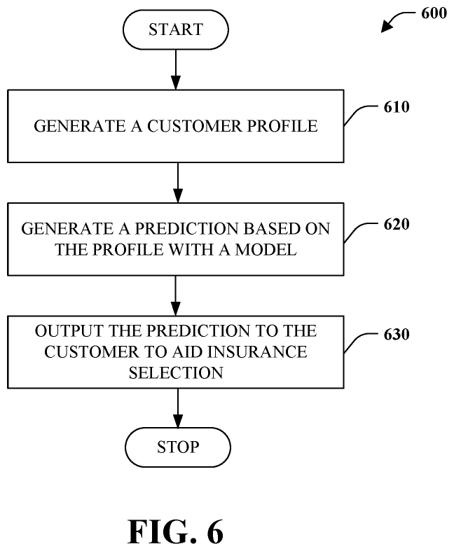

FIG. 6 is a flow chart diagram of a recommendation method 600 associated with insurance bidding. The recommendation method 600 can be provided by the insurance bidding system 100 and one or more components associated therewith. Alternatively, the recommendation method 600 can be embodied as a separate system or service that is employed by the insurance bidding system 100. At 610, a customer profile can be generated. Data regarding a financial institution customer and potential insurance customer can be collected and employed to produce a customer profile. Such data can include geographic location and credit score, among other things. A predictive model can be produced based on historical information regarding insurance bids, accepted bids, and customer profile. At numeral 620, a prediction can be generated from the model based at least on a provided customer profile. For example, given a particular credit score and location, the prediction can be an expected bid or range of bids. At numeral 630, the prediction can be output to the customer to aid insurance selection. In this manner, the customer can be provided with a premium similarly situated individuals are receiving to allow more intelligent selection of an insurance provider bid, or aid in constructing a counter bid or offer. Such recommendation method can also be employed to by insurance providers in generating bids.

Aspects of the subject disclosure concern a technical problem associated with automated insurance provisioning including acquisition and accessibility. The technical solution involves providing an insurance bidding platform or digital ecosystem. The platform can support simultaneous competition for business amongst multiple insurance providers. Data can be efficiently supplied as needed by the platform and without requiring an individual to enter data for each insurance provider. Furthermore, the platform can provide accessibility to particular third parties including auditors and regulators, among others. Further, a smart contract can be generated to capture transactional terms and conditions between an insured and insurance provider in program code. In accordance with one embodiment, block chain technology can be employed in conjunction with the smart contract to provide transparency, enhanced security, and transactional efficiency and speed by way of a decentralized, distributed, digital ledger. In one instance, a private or permissioned peer-to-peer network can be utilized to allow controlled access to transactional details.

The subject disclosure provides for various products and processes that are configured to perform insurance bidding and various functionality related thereto. What follows are one or more example systems and methods.

A system comprises a processor coupled to a memory that includes instructions that when executed by the processor cause the processor to communicate customer data associated with a loan from a financial institution to one or more insurance providers, convey, for display on a display device, offers for insurance received from the one or more insurance providers based on the customer data, construct a smart contract between the customer and one of the one or more insurance providers after the customer accepts a corresponding offer for insurance, and transmit the smart contract to a peer-to-peer network that saves the smart contract to a distributed database in a sequence of one or more blocks that are cryptographically secure and verified by copies in the peer-to-peer network. In instance, read access to the smart contract or data related thereto can be provided to one or more third-parties, such as an auditor, regulator, or investor. At least one of the one or more third-parties can be the financial institution or associated servicing entity that analyzes the smart contract to determine a monthly payment amount to collect from the customer for payment when due to the one of the one or more insurance providers. The system can also include instructions that cause the processor to further transmit a counter offer from the customer to at least one of the one or more insurance providers, and transmit the counter offer from the customer to the at least one of the one or more insurance providers. Instructions can additionally cause the processor to construct the smart contract after the at least one of the one or more insurance providers accepts the counter offer rather than before. The system can further include instructions that cause the processor to execute a predictive model to identify a suggested offer price for a customer based on the customer data and historical data including customer data and offers made by the one or more insurance providers. Subsequently, the suggested offer price can be conveyed to at least one of the customer or the one or more insurance providers. The instructions can further cause the processor to rank offers by the one or more insurance providers relevant to the suggested offer price and convey the rank to the customer for display on the display device. In accordance with one embodiment, at least one of the offers for insurance can be conditioned on purchase of at least one other insurance product.

A method comprises communicating customer data associated with a loan from a financial institution to one or more insurance providers, conveying, for display on a display device, offers for insurance received from the one or more insurance providers based on the customer data, constructing a smart contract between the customer and one of the one or more insurance provider after the customer accepts a corresponding offer for insurance, and transmitting the smart contract to a peer-to-peer network that saves the smart contract to a distributed database in a sequence of one or more blocks that are cryptographically secure and verified by copies in the peer-to-peer network. The method further comprises configuring details of the smart contract to be readable by one or more third-parties including at least one of an auditor, regulator, or the financial institution. The method further comprises transmitting a counter offer from the customer to at least one of the one or more insurance providers, and constructing the smart contract after the at least one insurance of the one or more insurance providers accepts the counter offer. The method further comprises executing a predictive model to identify a suggested offer price for a customer based on the customer data and historical data including customer data and offers made by the one or more insurance providers, and conveying the suggested offer price to at least one of the customer or the one or more insurance providers. The method further comprises ranking offers by the one or more insurance providers relevant to the suggested offer price, and conveying the rank to the customer for display on the display device.

A method comprises executing, on a processor, instructions that cause the processor to perform operations comprising communicating customer data associated with a mortgage from a financial institution to one or more insurance providers, conveying, for display on a display device, bids for mortgage insurance received from the one or more insurance providers based on the customer data, constructing a smart contract between the customer and one of the one or more insurance provider after the customer accepts a corresponding bid for insurance, transmitting the smart contract to a block chain network comprising peer-to-peer network that saves the smart contract to a distributed database in a sequence of one or more blocks that are cryptographically secure and verified by copies in the peer-to-peer network; and configuring read only access to the smart contract to a select number of third-party entities including at least one of an auditor or regulator. The operations further comprise executing a predictive model to identify a suggested bid price for a customer based on the customer data and historical data including customer data and bids made by the one or more insurance providers. The operations further comprise ranking the bids by the one or more insurance providers with respect to the suggested bid price and conveying the rank to the customer for display on the display device.

The term “customer” has been utilized herein to identify a mortgagee and insurance purchaser. The term is intended to refer to a human being, group of human beings (e.g. husband and wife) or an entity such as a business. In the context of mortgage insurance, the mortgagee can be a customer of a financial institution. Further, those seeking insurance can be customers, or at least potential customers, of insurance providers.

Aspects of the subject disclosure have been described substantially with respect to acquisition of mortgage insurance in conjunction with a mortgage loan to allow lenders or investors to be compensated for losses in the event of a default on the mortgage loan. However, the subject disclosure is not limited to mortgage insurance. In accordance with one alternative embodiment, aspects of the subject disclosure are applicable to other insurance products associated with vehicles such as automobile, boat, automobile, or motorcycle insurance, for instance. By way of example, if an individual seeks to acquire a loan for purchase or lease of an automobile, boat, or motorcycle, they may be required to acquire corresponding vehicle insurance to mitigate costs associated with accidents, among other things. In this case, a financial institution associated with providing a vehicle loan could provide customer information to the insurance bidding system 100 and direct the customer to the insurance bidding system 100 to acquire required insurance. In the case of automobile or motor cycle insurance the customer data could include age, gender, years of driving experience, accident and moving violation history, among other data. Subsequently, the insurance bidding system 100 can operate similar to mortgage insurance by providing customer data to a plurality of insurance providers who can generate bids, quotes, or offers based on customer data, and present such bids for selection and acceptance. After selection, a smart contract can be generated and saved to a secure distributed ledger replicated across computing device nodes or a peer-to-peer network.

Oftentimes insurance providers are able to provide a multi-policy discount such that the premium for mortgage insurance may be reduced if other policies are purchased through the insurance provider. Accordingly, mortgage insurance bids can indicate further discounts if the customer also purchases other policies such as home insurance or automobile insurance, The insurance bidding system 100 and associated processes can aid in connecting customers with insurance providers to apply for additional policies utilizing customer data in the system In one instance, bids can be solicited from insurance providers for multiple policies to facilitate comparison of cost and coverage.

In accordance with one embodiment, the insurance bidding system 100 can be limited to a single financial institution. For example, the system can be exclusive to a signal back to provide a competitive advantage. Alternatively, the insurance bidding system 100 can be open to multiple financial institutions for use in enabling their customers to select an insurance product from amongst a plurality of competitive bids from insurance providers. In one instance, the insurance bidding system 100 can be provided as a network-based service assessable to any number of financial institutions, insurance providers, customers, and third parties.

Various aspects of the subject disclosure can be provided in real time or near real time. For example, bids can be provided from an insurance provider to a potential customer in near real time. Likewise, a smart contract can be generated in near real time, among many other processes. Generally, real time can refer to the actual time at which a process or event occurs without delay. With automated systems, however, there is always some degree of delay associated with data processing and communication, among other things. In this context, real time refers to a response time in which the response is so close to instantly (e.g., sub-second) that a human does not notice any delay. However, this is a high bar to meet, especially in light of inherent physical latency as well as variations in communication and processing speed. As such, near real time is utilized to refer to time that is slightly longer than real time in which delay introduced by automated data processing and communication is taken into account.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

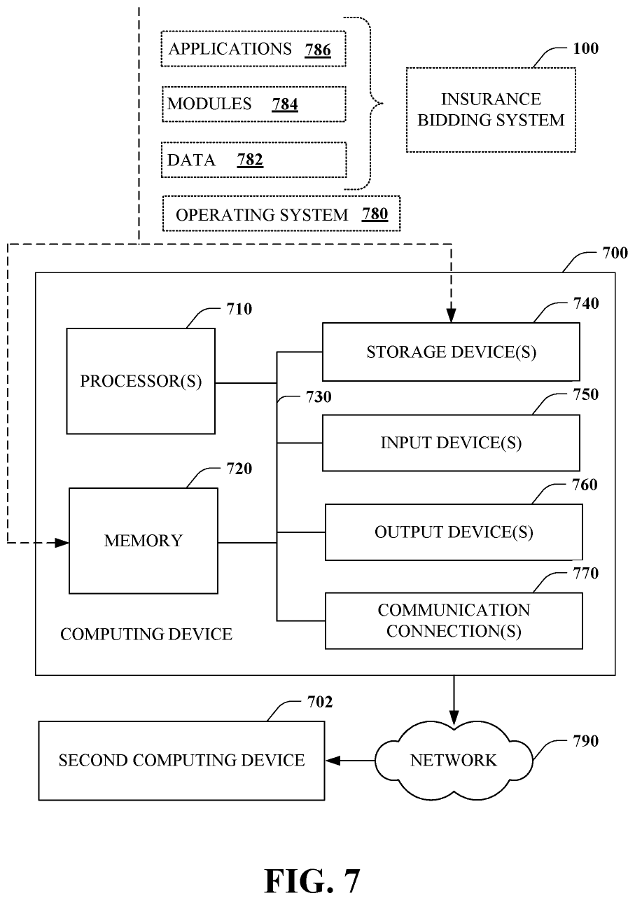

To provide a context for the disclosed subject matter, FIG. 7 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 7, illustrated is an example computing device 700 (e.g., desktop, laptop, tablet, watch, server, hand-held, programmable consumer or industrial electronics, set-top box, game system, compute node . . . ). The computing device 700 includes one or more processor(s) 710, memory 720, system bus 730, storage device(s) 740, input device(s) 750, output device(s) 760, and communications connection(s) 770. The system bus 730 communicatively couples at least the above system constituents. However, the computing device 700, in its simplest form, can include one or more processors 710 coupled to memory 720, wherein the one or more processors 710 execute various computer executable actions, instructions, and or components stored in the memory 720.

The processor(s) 710 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 710 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 710 can be a graphics processor unit (GPU) that performs calculations with respect to digital image processing and computer graphics.

The computing device 700 can include or otherwise interact with a variety of computer-readable media to facilitate control of the computing device to implement one or more aspects of the disclosed subject matter. The computer-readable media can be any available media that is accessible to the computing device 700 and includes volatile and nonvolatile media, and removable and non-removable media. Computer-readable media can comprise two distinct and mutually exclusive types, namely storage media and communication media.

Storage media includes volatile and nonvolatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 700. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 720 and storage device(s) 740 are examples of computer-readable storage media. Depending on the configuration and type of computing device, the memory 720 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 700, such as during start-up, can be stored in nonvolatile memory, while volatile memory can act as external cache memory to facilitate processing by the processor(s) 710, among other things.

The storage device(s) 740 include removable/non-removable, volatile/non-volatile storage media for storage of vast amounts of data relative to the memory 720. For example, storage device(s) 740 include, but are not limited to, one or more devices such as a magnetic or optical disk drive, floppy disk drive, flash memory, solid-state drive, or memory stick.

Memory 720 and storage device(s) 740 can include, or have stored therein, operating system 780, one or more applications 786, one or more program modules 784, and data 782. The operating system 780 acts to control and allocate resources of the computing device 700. Applications 786 include one or both of system and application software and can exploit management of resources by the operating system 780 through program modules 784 and data 782 stored in the memory 720 and/or storage device(s) 740 to perform one or more actions. Accordingly, applications 786 can turn a general-purpose computer 700 into a specialized machine in accordance with the logic provided thereby.

All or portions of the disclosed subject matter can be implemented using standard programming and/or engineering techniques to produce software, firmware, hardware, or any combination thereof to control the computing device 700 to realize the disclosed functionality. By way of example and not limitation, all or portions of the insurance bidding system 100 can be, or form part of, the application 786, and include one or more modules 784 and data 782 stored in memory and/or storage device(s) 740 whose functionality can be realized when executed by one or more processor(s) 710.

In accordance with one particular embodiment, the processor(s) 710 can correspond to a system on a chip (SOC) or like architecture including, or in other words integrating, both hardware and software on a single integrated circuit substrate. Here, the processor(s) 710 can include one or more processors as well as memory at least similar to the processor(s) 710 and memory 720, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the insurance bidding system 100 and/or functionality associated therewith can be embedded within hardware in an SOC architecture.

The input device(s) 750 and output device(s) 760 can be communicatively coupled to the computing device 700. By way of example, the input device(s) 750 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 760, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 750 and output device(s) 760 can be connected to the computing device 700 by way of wired connection (e.g., bus), wireless connection (e.g., Wi-Fi, Bluetooth . . . ), or a combination thereof.

The computing device 700 can also include communication connection(s) 770 to enable communication with at least a second computing device 702 by means of a network 790. The communication connection(s) 770 can include wired or wireless communication mechanisms to support network communication. The network 790 can correspond to a local area network (LAN) or a wide area network (WAN) such as the Internet. The second computing device 702 can be another processor-based device with which the computing device 700 can interact. For example, the computing device 700 can form part of a platform that exposes the insurance bidding system 100 as a service. The second computing device 702 can be utilized by a customer, insurance provider, or third party to interact with the insurance bidding system 100.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

1. A system, comprising:
a processor coupled to a memory that includes instructions that, when executed by the processor, cause the processor to:
automatically communicate customer data associated with a customer and a mortgage from a financial institution electronically to a plurality of insurance providers;
invoke a predictive model to infer, in real-time, an expected bid based on the customer data and historical information comprising other customer data associated with other customers and other offers made by more than one insurance provider of the plurality of insurance providers to the other customers and that were accepted by the other customers;
communicate the expected bid electronically to the plurality of insurance providers;
convey, for display on a display device associated with the customer, a plurality of offers for mortgage insurance on the mortgage, wherein the plurality of offers are received from the plurality of insurance providers after the communication of the expected bid to the plurality of insurance providers, and wherein each offer of the plurality of offers comprises a respective bid for a premium for the mortgage insurance;
convey, for display on the display device associated with the customer, the expected bid in conjunction with the plurality of offers;
in response to the customer accepting an offer of the plurality of offers, construct, in real-time, a smart contract between the customer and one insurance provider of the plurality of insurance providers; and
transmit the smart contract to a peer-to-peer network that saves the smart contract to a distributed database in a sequence of one or more blocks that are cryptographically secure and verified by copies in the peer-to-peer network.

2. The system of claim 1, wherein read access to the smart contract is provided to one or more third-party entities.

3. The system of claim 2, wherein at least one of the one or more third-party entities is an auditor, regulator, or investor.

4. The system of claim 2, wherein at least one of the one or more third-party entities is the financial institution that analyzes the smart contract to determine a monthly payment amount to collect from the customer for payment of when due to the one insurance provider of the plurality of insurance providers.

5. The system of claim 1, wherein the instructions further cause the processor to transmit a counter offer from the customer to at least one insurance provider of the plurality of insurance providers.

6. The system of claim 5, wherein the instructions cause the processor to construct the smart contract in response to the at least one insurance provider of the plurality of insurance providers accepting the counter offer.

7. (canceled)

8. (canceled)

9. The system of claim 1, wherein the instructions further cause the processor to rank the plurality of offers by the plurality of insurance providers in comparison to the expected bid and convey the rank to the customer for display on the display device.

10. The system of claim 1, wherein at least one offer of the plurality of offers is conditioned on a purchase of at least one other insurance product.

11. A method, comprising:
automatically communicating customer data associated with a customer and a mortgage from a financial institution electronically to a plurality of insurance providers;
invoking a predictive model to infer, in real-time, an expected bid based on the customer data and historical information comprising other customer data associated with other customers and other offers made by more than one insurance provider of the plurality of insurance providers to the other customers and that were accepted by the other customers;
communicating the expected bid electronically to the plurality of insurance providers;
conveying, for display on a display device associated with the customer, a plurality of offers for mortgage insurance on the mortgage, wherein the plurality of offers are received from the plurality of insurance providers after the communication of the expected bid to the plurality of insurance providers, and wherein each offer of the plurality of offers comprises a respective bid for a premium for the mortgage insurance;
conveying, for display on the display device associated with the customer, the expected bid in conjunction with the plurality of offers;
in response to the customer accepting an offer of the plurality of offers, constructing, in real-time, a smart contract between the customer and one insurance provider of the plurality of insurance providers; and
transmitting the smart contract to a peer-to-peer network that saves the smart contract to a distributed database in a sequence of one or more blocks that are cryptographically secure and verified by copies in the peer-to-peer network.

12. The method of claim 11, further comprising configuring the smart contract to be readable by one or more third-party entities including at least one of an auditor, regulator, or investor.

13. The method of claim 11, further comprising transmitting a counter offer from the customer to at least one insurance provider of the plurality of insurance providers.

14. The method of claim 13, wherein the smart contract is constructed in response to the at least one insurance provider of the plurality of insurance providers accepting the counter offer.

15. (canceled)

16. (canceled)

17. The method of claim 11, further comprising ranking the plurality of offers by the plurality of insurance providers in comparison to the expected bid and conveying the ranking to the customer for display on the display device.

18. A non-transitory computer-readable medium comprising:
instructions that, when executed, cause a processor to perform operations comprising:
automatically communicating customer data associated with a customer and a mortgage from a financial institution electronically to a plurality of insurance providers;
invoking a predictive model to infer, in real-time, an expected bid based on the customer data and historical information comprising other customer data associated with other customers and other offers made by more than one insurance provider of the plurality of insurance providers to the other customers and that were accepted by the other customers;
communicating the expected bid electronically to the plurality of insurance providers;
conveying, for display on a display device associated with the customer, a plurality of offers for mortgage insurance on the mortgage, wherein the plurality of offers are received from the plurality of insurance providers after the communication of the expected bid to the plurality of insurance providers, and wherein each offer of the plurality of offers comprises a respective bid for a premium for the mortgage insurance;
conveying, for display on the display device associated with the customer, the expected bid in conjunction with the plurality of offers;
in response to the customer accepting an offer of the plurality of offers, constructing, in real-time, a smart contract between the customer and one insurance provider of the plurality of insurance providers; and
transmitting the smart contract to a peer-to-peer network that saves the smart contract to a distributed database in a sequence of one or more blocks that are cryptographically secure and verified by copies in the peer-to-peer network.

19. (canceled)

20. The non-transitory computer-readable medium of claim 18, the operations further comprising ranking the plurality of offers by the plurality of insurance providers in comparison to the expected bid and conveying, for display on the display device, the ranking to the customer.

21. The system of claim 1, wherein the instructions further cause the processor to invoke the predictive model to evaluate the plurality of offers and generate a counter offer.

22. The system of claim 1, wherein the expected bid is a range of prices.

23. The method of claim 11, further comprising generating a counter offer based on the expected bid.

24. The non-transitory computer-readable medium of claim 18, wherein the operations further comprise generating a counter offer based on the expected bid.
